(19) United States
(12) Patent Application Publication
(10) Pub. No.: US 2010/0135016 A1
(43) Pub. Date: Jun. 3, 2010

(54) LAMP UNIT

(76) Inventor: Miyoji Ishibashi, Fukuoka (JP)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/522,475

(22) PCT Filed: Apr. 10, 2007
(86) PCT No.: PCT/JP2007/057916

§ 371 Date: Jan. 19, 2010

(30) Foreign Application Priority Data
Jan. 11, 2007 (JP) 2007-003821

(51) Int. Cl. F21V 1/00

(52) U.S. Cl. 362/235

(57) ABSTRACT

Disclosed is a lamp unit 10 which comprises a hat-shaped reflector 2 having an inner surface formed as a reflective surface for reflecting light, a plurality of bar-shaped light source lamps 1 each of which has an anchor end fixed to a vicinity of an end wall 2a of the reflector 2, and an insertion portion inserted inside the reflector 2 to protrude toward an opening of the reflector 2, and a reflection member 3 having an outer surface formed as a reflective surface. The reflection member 3 is disposed in a central region of the end wall 2a of the reflector 2 in such a manner to protrude toward the opening of the reflector 2. In the lamp unit, a protrusion length “d1” of the reflection member 3 is set in the range of one-third to three-fourths of a protrusion length “d2” of the insertion portion of each of the bar-shaped light source lamps 1. The present invention can optimize a positional relationship between the reflection member and each of the bar-shaped light source lamps so as to obtain enhanced illumination efficiency.

### BACKGROUND OF THE INVENTION

1. Field of the Invention

The present invention relates to a lamp unit suitable for a downlight fixture designed to be installed in a ceiling or the like of a building so as to illuminate a floor therebelow.

2. Description of the Related Art

In a lamp unit comprising a light source lamp and a reflector for reflecting light from the light source lamp, the reflector is a critical component having a great impact on illumination efficiency.

The inventor of this application previously proposed a reflector generally configured as a hat-shaped polyhedron which has an inner reflective surface formed by two downwardly-stepped slant surfaces different in inclination angle, as disclosed in the following Patent Publication 1. The inventor also proposed to provide three or more downwardly-stepped slant surfaces, as disclosed in the following Patent Publication 2. In the reflector having the above multi-stepped structure, the respective inclination angles of the downwardly-stepped inclined surfaces can be adjusted to control a light-reflection characteristic so as to illuminate a wider range in a uniform manner.

Nonetheless, in cases where a plurality of bar-shaped light source lamps (e.g., fluorescent lamps) are used for improvement in illumination intensity, lights from the bar-shaped light source lamps will be cancelled out due to interference therebetween to cause a problem that lights from the bar-shaped light source lamps cannot be effectively utilized for illumination to result in poor illumination intensity, and an illuminated region on a planar surface has a guitar shape.

As measures against the above problem associated with the use of plurality of bar-shaped light source lamps, the inventor suggested that a reflection member having an outer surface serving as a reflective surface is effectively disposed in a central region of a top wall of the reflector in such a manner as to protrude toward an opening of the reflector, as disclosed in the following Patent Publication 3.

However, in a lamp unit disclosed in the Patent Publication 3, a positional relationship between the reflection member and each of the bar-shaped light source lamps is not optimized, and therefore there remains the need for improvement in illumination efficiency.

[Patent Publication 1] JP 2003-151310A

[Patent Publication 2] JP 2005-346968A

[Patent Publication 3] JP 2006-059707A

### SUMMARY OF THE INVENTION

In view of the above problem in the lamp unit which comprises the reflector having the reflection member and the plurality of bar-shaped light source lamps each inserted into the reflector, it is an object of the present invention to optimize a positional relationship between the reflection member and each of the bar-shaped light source lamps so as to obtain enhanced illumination efficiency.

Through various researches for achieving the above object, the inventor of this application found that respective protrusion lengths of the reflection member and each of the bar-shaped light source lamps have a significant influence on illumination efficiency of the lamp unit. The inventor also found that the illumination efficiency is enhanced when the protrusion length of the reflection member is set in the range of one-third to three-fourths of the protrusion length of each of the bar-shaped light source lamps. Based on this knowledge, the inventor has accomplished the present invention.

Specifically, the present invention provides a lamp unit which comprises a hat-shaped reflector having an inner surface formed as a reflective surface for reflecting light, a plurality of bar-shaped light source lamps each of which has an anchor end fixed to a vicinity of an end wall of the reflector, and an insertion portion inserted inside the reflector to protrude toward an opening of the reflector, and a reflection member having an outer surface formed as a reflective surface. The reflection member is disposed in a central region of the end wall of the reflector in such a manner to protrude toward the opening of the reflector. In the lamp unit, a protrusion length of the reflection member is set in the range of one-third to three-fourths of a protrusion length of the insertion portion of each of the bar-shaped light source lamps.

In the lamp unit of the present invention, illumination efficiency can be enhanced by allowing the protrusion length of the reflection member to be set in the range of one-third to three-fourths of the protrusion length of the insertion portion of each of the bar-shaped light source lamps. If the protrusion length of the reflection member is set to be less than one-third of the protrusion length of the insertion portion of the bar-shaped light source lamp, the illumination efficiency will deteriorate. Contrariwise, if the protrusion length of the reflection member is set to be greater than three-fourths of the protrusion length of the insertion portion of the bar-shaped light source lamp, a presence of the reflection member is liable to adversely hinder light reflection in the reflector to cause the occurrence of a shadow on an illumination target, such as a floor.

In the lamp unit of the present invention, a distance between respective opposed positions of the reflective surface of the reflection member and an outer peripheral surface of the insertion portion of each of the bar-shaped light source lamps is preferably set at 8 mm or more, more preferably in the range of 8 to 10 mm. If the distance is set to be less than 8 mm, reflection efficiency of the reflective surface of the reflection member will deteriorate.

In the lamp unit of the present invention, when the insertion portion of each of the bar-shaped light source lamps is formed to have a prismatic-shaped outer peripheral surface, any one or more facets of the prismatic-shaped outer peripheral surface located opposed to a certain region of the reflective surface of the reflection member are preferably positioned in non-parallel relation to the region of the reflective surface of the reflection member. According to this feature, light from each of the bar-shaped light source lamps will be reflected in a direction different from a direction oriented toward the insertion portion of the bar-shaped light source lamp. Thus, the reflected light can be effectively utilized for illumination to obtain further enhanced illumination efficiency.

Preferably, in the lamp unit of the present invention, the reflective surface of the reflection member has three or more facets. According to this feature, the reflective surface of the reflection member having three or more facets can multi-directionally reflect light from each of the bar-shaped light source lamps to obtain enhanced uniformity in illumination.

In the lamp unit having the above features of the present invention, light from each of the plurality of bar-shaped light source lamps can be efficiently reflected by the reflection member disposed in the central region of the end wall of the reflector to provide enhanced illumination efficiency to the lamp unit. This means that the same illumination intensity as that in a conventional lamp unit can be obtained using a less number of bar-shaped light source lamps than that in the conventional lamp, so as to drastically reduce power consumption. This also makes it possible to reduce heat generation of the lamp unit so as to obtain enhanced in-building air-conditioning efficiency.

### BRIEF DESCRIPTION OF THE DRAWINGS

FIG. 1 is a sectional view showing a downlight fixture according to a first embodiment of the present invention.

FIG. 2 is a perspective view showing a reflector used in the downlight fixture in FIG. 1.

FIG. 3 is an explanatory diagram showing a preferred positional relationship between a reflection member and an insertion portion of a bar-shaped light source lamp.

FIG. 4 is a sectional view showing a downlight fixture according to a second embodiment of the present invention.

FIG. 5 is a perspective view showing a reflector used in the downlight fixture in FIG. 4.

FIG. 6 is a sectional view showing a downlight fixture according to a third embodiment of the present invention.

FIG. 7 is a perspective view showing a reflector used in the downlight fixture in FIG. 6.

### DESCRIPTION OF THE PREFERRED EMBODIMENTS

The present invention will now be specifically described based on an embodiment thereof illustrated in the accompanying drawings, wherein the present invention is applied to a downlight fixture as one example of a lamp unit.

### [First Embodiment]

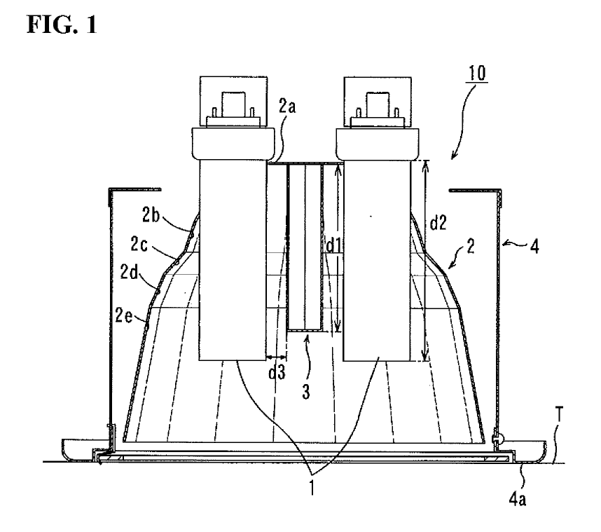

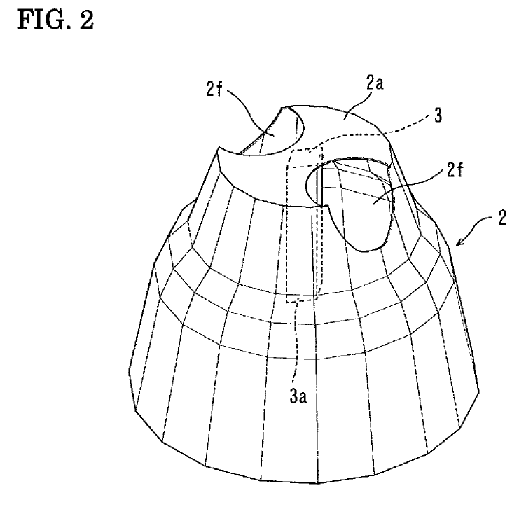

FIG. 1 is a sectional view showing a downlight fixture according to a first embodiment of the present invention, and FIG. 2 is a perspective view showing a reflector used in the downlight fixture in FIG. 1.

As shown in FIG. 1, the downlight fixture 10 comprises two bar-shaped light source lamps 1 each consisting of a fluorescent tube lamp, a reflector 2 for reflecting light from each of the bar-shaped light source lamps 1, a reflection member 3 for reflecting light from each of the bar-shaped light source lamps 1, and a lamp body 4 to which the reflector 2 is fixed.

Each of the two bar-shaped light source lamps 1 has an upper end portion (i.e., anchor portion) fixed to a vicinity of a top wall 2a (serving as an end wall) of the reflector 2, and a luminous portion (generally serving as an insertion portion) located inside the reflector 2 to protrude downwardly (i.e., toward an opening of the reflector 2). The two bar-shaped light source lamps 1 are disposed in parallel relation to each other, as shown in FIG. 1.

In the first embodiment, the reflector 2 is formed as a hat-shaped octadegonal (i.e., eighteen-faceted) prism having a regular octadecagon (i.e., eighteen-sided polygon) in bottom view (or horizontal cross-sectional view). The reflector 2 has an inner surface serving as a reflective surface which is formed as four downwardly-stepped slant surfaces consisting of a 1st slant surface 2b, a 2nd slant surface 2c, a 3rd slant surface 2d and a 4th slant surface 2e and each having a different inclination angle. Dimensions of the reflector 2 and respective lengths and inclination angles of the 1st to 4th slant surfaces 2b to 2e may be appropriately determined depending on use conditions, such as a ceiling height and a desired illumination range in an installation location of the downlight fixture 10.

The reflector 2 has a substrate made of aluminum, and an inner surface of the aluminum substrate is coated with a titanium-silicon alloy to form a mirror-like surface so as to provide the reflective surface. A material of the substrate of the reflector 2 is not limited to aluminum, but any other metal material may be used. Further, the reflective surface of the reflector 2 may be obtained by subjecting a metal plate to a mirror finishing process. In FIG. 2, the reference codes 2f, 2f indicate two cutouts for allowing the respective bar-shaped light source lamps 1 to be inserted into the reflector 2 during assembling.

The reflection member 3 is disposed to protrude from a central region (i.e., a region located between the two bar-shaped light source lamps 1) of an inner surface of the top wall 2a of the reflector 2 downwardly (i.e., toward the opening of the reflector 2). In the first embodiment, the reflection member 3 is formed in a quadrangular prismatic shape which has four outer facets serving as a reflective surface 3a.

The lamp body 4 is provided with a ring-shaped support member 4a fixed to a lower end thereof to protrude from an outer peripheral surface of the lower end horizontally and outwardly. The support member 4a is adapted to be mounted on a rear surface of a ceiling T so as to allow an entirety of the downlight fixture 10 to be suspended by the rear surface of the ceiling T.

In the downlight fixture 10 having the above structure, a protruding length “d1” of the reflection member 3 is set in the range of one-third (⅓) to three-fourths (¾) of a protrusion length “d2” of each of an insertion portion of the bar-shaped light source lamps 1 located inside the reflector 2. Further, in the first embodiment, a distance between respective opposed positions of (i.e., a closest distance between) the reflective surface 3a of the reflection member 3 and an outer peripheral surface of the insertion portion of each of the bar-shaped light source lamps 1 is set at 8 mm or more.

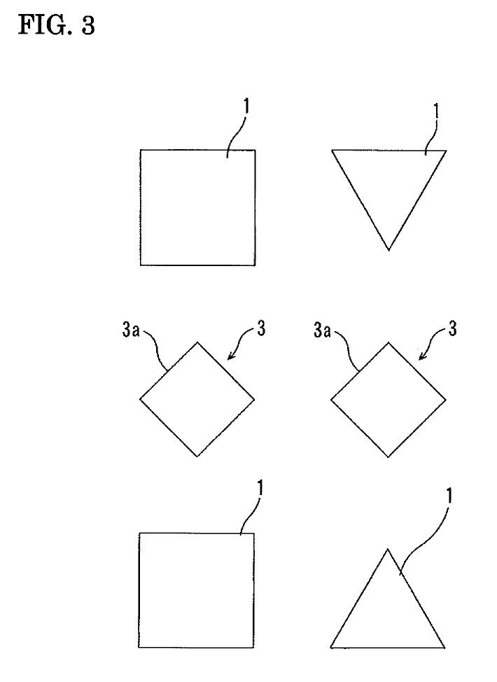

FIG. 3 is an explanatory diagram showing a preferred positional relationship between the reflection member 3 and the insertion portion of each of the bar-shaped light source lamps 1. As shown in FIG. 3, when the insertion portion of the bar-shaped light source lamp 1 is formed to have a prismatic-shaped outer peripheral surface, any one or more facets of the prismatic-shaped outer peripheral surface located opposed to any one or more of the four facets of the reflective surface 3a of the reflection member 3 are preferably positioned in non-parallel relation to the one or more facets of the reflective surface 3a of the reflection member 3. In this case, light from each of the bar-shaped light source lamps 1 is reflected in a direction different from a direction oriented toward the bar-shaped light source lamp 1. Thus, the reflected light can be effectively utilized for illumination to obtain further enhanced illumination efficiency. As used in this specification, the term “prismatic-shaped outer peripheral surface” of the bar-shaped light source lamp 1 means that an outer shape (or contour) of the bar-shaped light source lamp 1 is not strictly limited to a perfect prismatic shape but may be an approximately prismatic shape.

In the downlight fixture 10 according to the first embodiment, lights emitted from the two bar-shaped light source lamps 1 toward an axis of the reflector 2 are reflected by the reflective surface 3a of the reflection member 3 without interference therebetween. Then, the respective reflected lights are reflected by the inner surface, i.e., reflective surface, of the reflector 2 plural times, and released from the opening of the reflector 2 to illuminate a floor. Concurrently, lights emitted from the two bar-shaped light source lamps 1 directly toward the inner surface of the reflector 2 are also reflected by the inner surface, i.e., reflective surface, of the reflector 2 plural times, and released from the opening of the reflector 2 to illuminate a floor. In this manner, the lights from the bar-shaped light source lamps 1 can be fully utilized for illumination to obtain significantly enhanced illumination efficiency.

### [Second Embodiment]

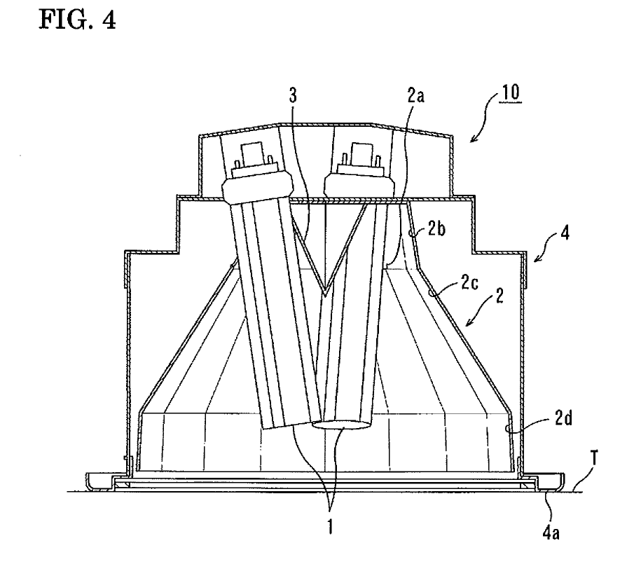

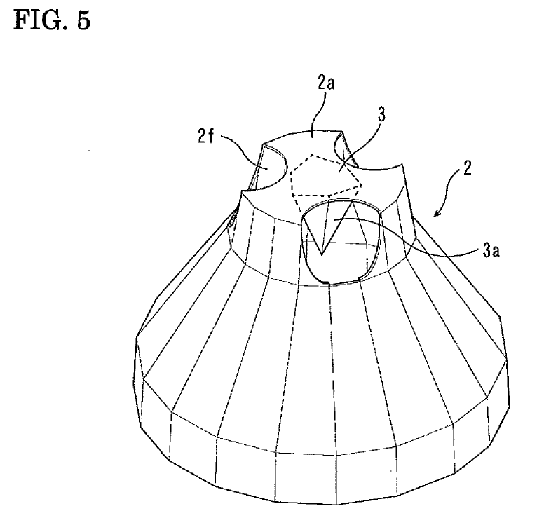

FIG. 4 is a sectional view showing a downlight fixture according to a second embodiment of the present invention, and FIG. 5 is a perspective view showing a reflector used in the downlight fixture in FIG. 4.

In the downlight fixture 10 illustrated in FIG. 4, three bar-shaped light source lamps 1 are inserted into the reflector 2 through respective ones of three cutouts 2f formed in the reflector 2.

Each of the three bar-shaped light source lamps 1 has an upper end portion (i.e., anchor portion) fixed to a vicinity of a top wall 2a (serving as an end wall) of the reflector 2, and a luminous portion (generally serving as an insertion portion) located inside the reflector 2 to protrude downwardly (i.e., toward an opening of the reflector 2). The three bar-shaped light source lamps 1 are disposed in such a manner that a distance between respective ones thereof gradually decreases in a downward direction, as shown in FIG. 4.

In the second embodiment, the reflector 2 is formed as a hat-shaped octadegonal (i.e., eighteen-faceted) prism having a regular octadecagon (i.e., eighteen-sided polygon) in bottom view (or horizontal cross-sectional view). The reflector 2 has an inner surface serving as a reflective surface which is formed as three downwardly-stepped slant surfaces consisting of a 1st slant surface 2b, a 2nd slant surface 2c and a 3rd slant surface 2d and each having a different inclination angle. Dimensions of the reflector 2 and respective lengths and inclination angles of the 1st to 3rd slant surfaces 2b to 2d may be appropriately determined depending on use conditions, such as a ceiling height and a desired illumination range in an installation location of the downlight fixture 10. A substrate and the inner surface of the reflector 2 are prepared in the same manner as that in the first embodiment.

The reflection member 3 is disposed to protrude from a central region (i.e., a region located surrounded by the three bar-shaped light source lamps 1) of an inner surface of the top wall 2a of the reflector 2 downwardly (i.e., toward the opening of the reflector 2). In the second embodiment, the reflection member 3 is formed in a six-sided pyramid shape which has six outer facets serving as a reflective surface 3a.

The lamp body 4 has the same structure as that in the first embodiment. That is, the lamp body 4 is provided with a ring-shaped support member 4a fixed to a lower end thereof to protrude from an outer peripheral surface of the lower end horizontally and outwardly. The support member 4a is adapted to be mounted on a rear surface of a ceiling T so as to allow an entirety of the downlight fixture 10 to be suspended by the rear surface of the ceiling T.

As with the first embodiment, in the downlight fixture 10 according to the second embodiment, a protruding length of the reflection member 3 is set in the range of one-third (⅓) to three-fourths (¾) of a protrusion length of each of a portion of the bar-shaped light source lamps 1 located inside the reflector 2 (i.e., a length of the luminance portion of each of the bar-shaped light source lamps 1). In cases where each of the bar-shaped light source lamps 1 is inserted into the reflector 2 at a slant as in the second embodiment, the term “protrusion distance” of the bar-shaped light source lamp 1 means a projected length of an actual protrusion length to a vertical line (i.e., an axis of the reflector 2). The term “protrusion distance” of the reflection body 3 also means a projected length of an actual protrusion length to a vertical line (i.e., an axis of the reflector 2).

Further, in the second embodiment, a distance between respective opposed positions of (i.e., a closest distance between) the reflective surface 3a of the reflection member 3 and an outer peripheral surface of the insertion portion of each of the bar-shaped light source lamps 1 is set at 8 mm or more, in the same manner as that in the first embodiment.

The downlight fixture 10 according to the second embodiment can obtain significantly enhanced illumination efficiency, as with the first embodiment.

### [Third Embodiment]

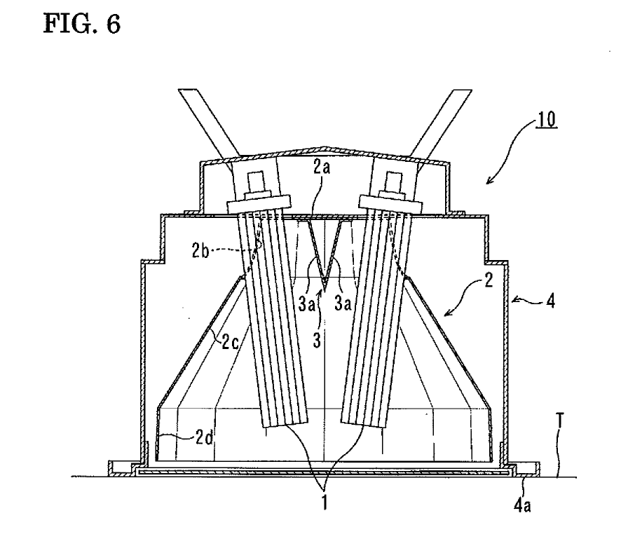

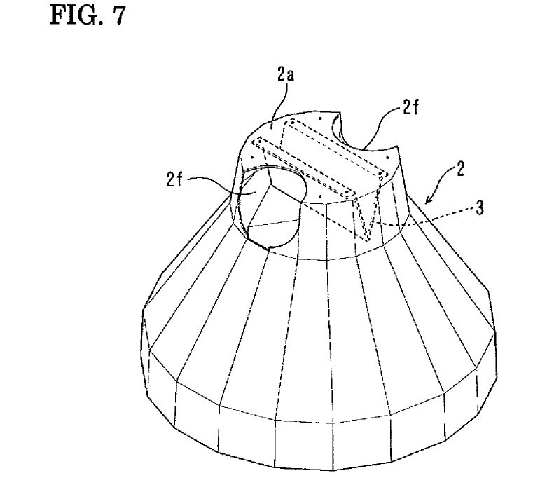

FIG. 6 is a sectional view showing a downlight fixture according to a third embodiment of the present invention, and FIG. 7 is a perspective view showing a reflector used in the downlight fixture in FIG. 6.

In the downlight fixture 10 illustrated in FIG. 6, two bar-shaped light source lamps 1 are inserted into the reflector 2 through respective ones of two cutouts 2f formed in the reflector 2.

Each of the two bar-shaped light source lamps 1 has an upper end portion (i.e., anchor portion) fixed to a vicinity of a top wall 2a (serving as an end wall) of the reflector 2, and a luminous portion (generally serving as an insertion portion) located inside the reflector 2 to protrude downwardly (i.e., toward an opening of the reflector 2). The two bar-shaped light source lamps 1 are disposed to form a V shape, i.e., in such a manner that a distance between respective ones thereof gradually decreases in a downward direction, as shown in FIG. 6.

In the third embodiment, the reflector 2 is formed as a hat-shaped octadegonal (i.e., eighteen-faceted) prism having a regular octadecagon (i.e., eighteen-sided polygon) in bottom view (or horizontal cross-sectional view). The reflector 2 has an inner surface serving as a reflective surface which is formed as three downwardly-stepped slant surfaces consisting of a 1st slant surface 2b, a 2nd slant surface 2c and a 3rd slant surface 2d and each having a different inclination angle. Dimensions of the reflector 2 and respective lengths and inclination angles of the 1st to 3rd slant surfaces 2b to 2d may be appropriately determined depending on use conditions, such as a ceiling height and a desired illumination range in an installation location of the downlight fixture 10. A substrate and the inner surface of the reflector 2 are prepared in the same manner as that in the first embodiment.

The reflection member 3 is disposed to protrude from a central region (i.e., a region located between the two bar-shaped light source lamps 1) of an inner surface of the top wall 2a of the reflector 2 downwardly (i.e., toward the opening of the reflector 2). In the third embodiment, the reflection member 3 is formed to have two lateral surfaces each located opposed to a corresponding one of the two bar-shaped light source lamps 1 to serve as a reflective surface 3a. The two lateral surfaces, i.e., two reflective surfaces 3a, are formed in a V shape, i.e., in such a manner that a distance therebetween gradually decreases in a downward direction.

The lamp body 4 has the same structure as that in the first embodiment. That is, the lamp body 4 is provided with a ring-shaped support member 4a fixed to a lower end thereof to protrude from an outer peripheral surface of the lower end horizontally and outwardly. The support member 4a is adapted to be mounted on a rear surface of a ceiling T so as to allow an entirety of the downlight fixture 10 to be suspended by the rear surface of the ceiling T.

As with the first and second embodiments, in the downlight fixture 10 according to the third embodiment, a protruding length of the reflection member 3 is set in the range of one-third (⅓) to three-fourths (¾) of a protrusion length of each of a portion of the bar-shaped light source lamps 1 located inside the reflector 2 (i.e., a length of the luminance portion of each of the bar-shaped light source lamps 1). Further, in the third embodiment, a distance between respective opposed positions of (i.e., a closest distance between) the reflective surface 3a of the reflection member 3 and an outer peripheral surface of the insertion portion of each of the bar-shaped light source lamps 1 is set at 8 mm or more, in the same manner as that in the first and second embodiments.

The downlight fixture 10 according to the third embodiment can obtain significantly enhanced illumination efficiency, as with the first and second embodiments.

### INDUSTRIAL APPLICABILITY

The present invention is usable as a lamp unit adapted to be mounted to a wall or a floor of a building, as well as a downlight fixture adapted to be mounted to a ceiling of a building.

1. A lamp unit comprising:
a hat-shaped reflector having an inner surface formed as a reflective surface for reflecting light;
a plurality of bar-shaped light source lamps each of which has an anchor end fixed to a vicinity of an end wall of said reflector, and an insertion portion inserted inside said reflector to protrude toward an opening of said reflector; and
a reflection member having an outer surface formed as a reflective surface, said reflection member being disposed in a central region of said end wall of said reflector in such a manner to protrude toward said opening of said reflector,
wherein a protrusion length of said reflection member is set in the range of one-third to three-fourths of a protrusion length of said insertion portion of each of said bar-shaped light source lamps.

2. The lamp unit as defined in claim 1, wherein a distance between respective opposed positions of said reflective surface of said reflection member and an outer peripheral surface of said insertion portion of each of said bar-shaped light source lamps is set at 8 mm or more.

3. The lamp unit as defined in claim 1, wherein said insertion portion of each of said bar-shaped light source lamps is formed to have a prismatic-shaped outer peripheral surface, wherein anyone or more facets of said prismatic-shaped outer peripheral surface located opposed to a certain region of said reflective surface of said reflection member are positioned in non-parallel relation to said region of said reflective surface of said reflection member.

4. The lamp unit as defined in claim 1, wherein said reflective surface of said reflection member has three or more facets.

5. The lamp unit as defined in claim 2, wherein said reflective surface of said reflection member has three or more facets.

6. The lamp unit as defined in claim 3, wherein said reflective surface of said reflection member has three or more facets.

7. The lamp unit as defined in claim 2, wherein said insertion portion of each of said bar-shaped light source lamps is formed to have a prismatic-shaped outer peripheral surface, wherein anyone or more facets of said prismatic-shaped outer peripheral surface located opposed to a certain region of said reflective surface of said reflection member are positioned in non-parallel relation to said region of said reflective surface of said reflection member.

8. The lamp unit as defined in claim 7, wherein said reflective surface of said reflection member has three or more facets.
